(19) United States
(12) Patent Application Publication
(10) Pub. No.: US 2020/0271193 A1
(43) Pub. Date: Aug. 27, 2020

(54) SYNTHETIC ROPE SOCKET WITH SOLID THIMBLE

(71) Applicant: WASHINGTON CHAIN & SUPPLY, INC., SEATTLE, WA (US)

(72) Inventors: GABRIEL BENAVIDEZ, WOODINVILLE, WA (US); STEVE ROW, FEDERAL WAY, WA (US); LANCE EGGERS, SEATTLE, WA (US); JORDAN A. FIEDLER, SEATTLE, WA (US)

(21) Appl. No.: 15/931,475

(22) Filed: May 13, 2020

Related U.S. Application Data
(63) Continuation-in-part of application No. 16/174,990, filed on Oct. 30, 2018.

(51) Int. Cl. F16G 11/14; F16G 11/04; F16G 11/02

(52) U.S. Cl. CPC F16G 11/146; F16G 11/025; F16G 11/046

(57) ABSTRACT

A device and method for the end termination of a braided synthetic rope offering full efficiency of the spliced and unspliced, tensile strength of the subject synthetic rope, with a tapered solid compression thimble of unique surface topography allowing forces on the tapered solid compression thimble only in compression, seated inside an enclosing thimble socket with an internal tapered thimble seat free of sharp edges, with a screw-on cap at the top of the enclosing thimble socket with a fitting for attachment for connecting links and configurable for different rigging attachment styles, a contoured groove in the tapered solid compression thimble for receiving a braided synthetic rope wrapped around the solid compression thimble and spliced into itself. Rounded edges at the bottom of the enclosing thimble socket help protect the braided synthetic rope from abrasion and cutting while in service. Also provided is a screw-on cap with an adjustable externally threaded extension rod to receive an internally threaded clevis jaw and pin end fitting positioned as desired on the extension rod with a lock nut. The device is intended to create a job-site qualified, safe and efficient manner to connect objects in the rigging and mooring industry such as other synthetic mooring lines, tow lines, anchor chains, and wire ropes.

This application is a Continuation-in-part of application Ser. No. 16/174,990 (the ‘990 application’) filed Oct. 30, 2018, co-owned with the present invention. The '990 application is incorporated here by reference for all purposes, and with respect to all of which the present invention claims priority under United States Patent Law.

### BACKGROUND OF THE INVENTION

The invention relates to a device and method for the end termination of a braided synthetic rope that is currently being used in the mooring of any or all offshore drilling, and production facilities, towing and other crane & rigging applications. Moreover the invention relates to a preferably alloy metal termination, or other suitably engineered material, of braided synthetic rope which will enhance the protection of mooring lines and other synthetic rope applications at the end fitting, will reduce installation times in turn reducing costs, and will utilize standard wire rope, and/or chain connectors. The device and method is intended to create a safe and efficient manner to connect objects in the mooring and rigging industry such as other synthetic mooring lines, tow lines, anchor chains, and wire ropes.

The offshore oil production industry, due to the increased demand from the marketplace for oil production, has constantly improved their technology and capabilities to explore and to drill in deeper waters. While ongoing upgrades are taking place on the current drilling fleets the weight increases that they are subjected to because of longer and heavier mooring lines, an alternative innovation solution had to be explored to address these issues. Braided synthetic ropes are being used much more often to replace the heavier more cumbersome steel wire rope thus requiring synthetic ropes to undergo many changes in design and use. The synthetic rope fittings have been large, heavy and cumbersome resulting in long installation times, increased labor hours, and safety concerns for employees. The braided synthetic rope socket of this invention helps to resolve many of these issues. The current method of terminating a synthetic rope with a metal connector requires sending the rope to specialized connector manufacturers for in-house mating of the rope to the specialized socket and is time consuming and expensive. The advantages of the inventive synthetic rope socket is that it can be installed in the field on a braided synthetic rope and fitted with any custom end connection required for terminating the synthetic rope. Due to the design of the braided synthetic rope socket of the present invention there are no sharp or mitered edges to cut or cause abrasions, all corners or edges are rounded to protect the integrity of the synthetic rope.

### SUMMARY OF THE INVENTION

The inventive synthetic rope socket includes a braided rope tapered solid compression thimble and enclosing tapered socket with screw-on cap used for the end termination of braided synthetic ropes offering 100% efficiency of the tensile strength of the subject synthetic rope and ease of connections. With the design of this apparatus it will allow for quick and efficient field assembly. The design of the apparatus will allow for the connection of synthetic ropes to other devices such as chains, wire ropes, and even other synthetic ropes without the need for intermediate hardware designed for the protection of the synthetic rope. The apparatus also has the capabilities of being customized to fit any connection point with the removable screw-on cap.

It is an object of this invention to provide a device for the end termination of braided synthetic rope, comprising; a tapered solid compression thimble with a rope entry and exit end, a top end, a longitudinal exterior contoured groove with rounded surfaces for the synthetic rope, extending from the rope entry and exit end of the tapered solid compression thimble to the top end of the tapered solid compression thimble, and where the unique surface topography/shape of the tapered solid compression thimble can be described mathematically as a parametric surface with third-order Gaussian geometry; an enclosing thimble socket with a rope entry and exit end, a rope entry and exit end opening with rounded edges at the rope entry end for insertion of the braided synthetic rope and extension through the rope entry end to the rope entry end of the tapered solid compression thimble and folded back and placed in the contoured groove of the tapered solid compression thimble and spliced onto itself, a solid compression thimble entry end a solid compression thimble opening, an internal tapered thimble seat in the enclosing thimble socket to receive the tapered solid compression thimble, internal female threads in the tapered thimble seat at the solid compression thimble entry end with a locking screw mechanism; a screw-on cap having a thimble socket engagement end and a fitting end with external threads at the socket engagement end for threaded engagement with the internal threads in the tapered solid compression thimble seat at the solid compression thimble entry end of the enclosing thimble socket after the tapered solid compression thimble is seated in the enclosing thimble socket; and a socket fitting fixedly attached to the fitting end of the screw-on cap and secured with a locking screw mechanism.

It is also an object of this invention to provide a method for the end termination of braided synthetic rope comprising the steps of: inserting the end of a braided synthetic rope through an enclosing thimble socket with a rope entry and exit end, a rope entry end opening with rounded edges at the rope entry end, said enclosing thimble socket also having a solid compression thimble entry end, an internal tapered thimble seat to receive a tapered solid compression thimble with a longitudinal exterior contoured groove for the synthetic rope and a rope entry and exit end, and internal female threads in the tapered solid compression thimble seat at the solid compression thimble entry end; drawing the end of the braided synthetic rope inserted through the rope entry end opening of the enclosing thimble socket in sufficient length to wrap the braided synthetic rope over and around the tapered solid compression thimble in the contoured groove from the rope entry and exit end over a top end with rounded surfaces and splice onto itself, the unique shape of the tapered solid compression thimble can be described mathematically as a parametric surface with third-order Gaussian geometry designed to transfer the minimum amount of strain onto the braided synthetic rope; splicing the braided synthetic rope onto itself after being wrapped over and around the tapered solid compression thimble in the contoured groove; pulling the spliced synthetic rope to draw and seat the tapered solid compression thimble in the enclosing thimble socket through the solid compression thimble opening at the solid compression thimble entry end, and; at the solid compression thimble entry end of the enclosing thimble socket threading a screw-on cap with a fixed socket fitting, with external threads, and secured with a locking screw mechanism. As an additional step the spliced braided synthetic rope would be wrapped in an anti-chafe material.

It is also an object of this invention to provide a device for the end termination of braided synthetic rope further comprising a screw-on cap with an adjustable externally threaded extension rod to receive an internally threaded clevis jaw and pin end fitting positioned as desired on the extension rod with a lock nut.

It is also an object of this invention to provide a method for the end termination of braided synthetic rope further comprising a screw-on cap with an adjustable externally threaded extension rod to receive an internally threaded clevis jaw and pin end fitting positioned as desired on the extension rod with a lock nut.

### BRIEF DESCRIPTION OF THE DRAWINGS

For a further understanding of the nature, objects and advantages of the invention, reference should be had to the following detailed description, read in conjunction with the following drawings.

FIG. 1 is a side view of two assembled inventive synthetic rope sockets, terminating both ends of a braided synthetic rope and showing enclosing thimble sockets, screw-on caps and fitting end.

FIG. 2 is an exploded view of the inventive synthetic rope socket showing a tapered solid compression thimble, the enclosing thimble socket, the screw-on cap with fitting end, and a braided synthetic rope spliced into a loop formed around the tapered solid compression thimble in a longitudinal exterior contoured groove.

FIG. 3 is a side view of the assembled inventive synthetic rope socket showing enclosing thimble sockets, screw-on caps and fitting end.

FIG. 4 is a side view of the screw-on cap with a fitting end, in position above a cross section of the enclosing thimble socket without the tapered solid compression thimble.

FIG. 5 is a perspective view of one embodiment of the tapered solid compression thimble.

FIGS. 6, 7, 8, and 9 are view of an alternate embodiment of the tapered solid compression thimble with an optimized lower weight design.

FIG. 10 is a side cross sectional view of the complete and assembled inventive synthetic rope socket with tapered solid compression thimble and a braided synthetic rope spliced into a loop around the tapered solid compression thimble in a longitudinal exterior contoured groove.

FIG. 11 is another view of the end of a braided synthetic rope spliced into a loop that would be formed around the tapered solid compression thimble in a longitudinal exterior contoured groove.

FIG. 12 is another side cross sectional view of the complete and assembled inventive synthetic rope socket with the tapered solid compression thimble rotated 90 degrees about a longitudinal axis from the view given in FIG. 10, and a braided synthetic rope spliced into a loop around the tapered solid compression thimble in a longitudinal exterior contoured groove.

FIG. 13 is a side view of an alternative screw-on cap with a threaded extension rod with lock nut shown below a partial cross section of an end fitting with clevis jaw and pin, all in position above a cross section of the enclosing thimble socket without the tapered solid compression thimble.

FIG. 14 is a side view of an alternative screw-on cap with a threaded extension rod with lock nut shown below a partial cross section of an end fitting with clevis jaw and pin turned 90 degrees from the image shown in FIG. 14, all in position above a cross section of the enclosing thimble socket without the tapered solid compression thimble.

### DETAILED DESCRIPTION OF THE INVENTION

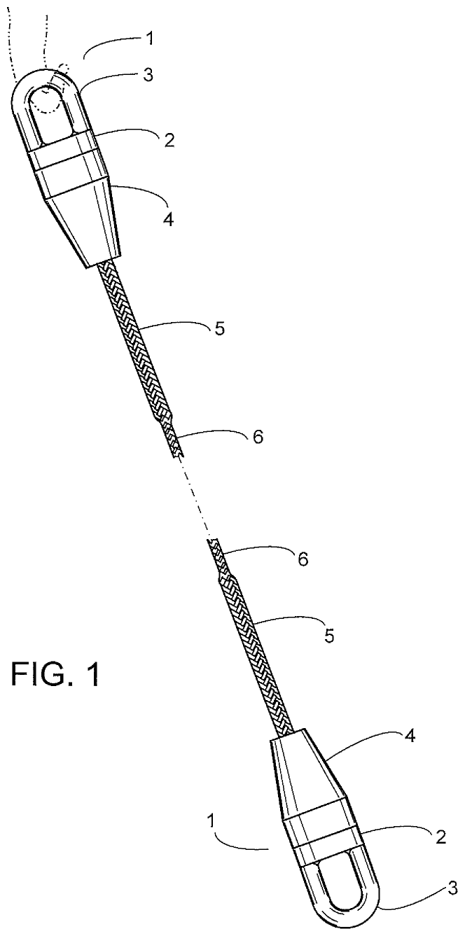

FIG. 1 is illustrative of the use of the inventive synthetic rope socket 1 to terminate both ends of a braided synthetic rope 6. There is shown a synthetic rope splice 5 extending from the rope exit end and rope entry end 14 of an enclosing thimble socket 4 that is attached to a screw-on cap 2 with a fitting end 3 shown as an eye.

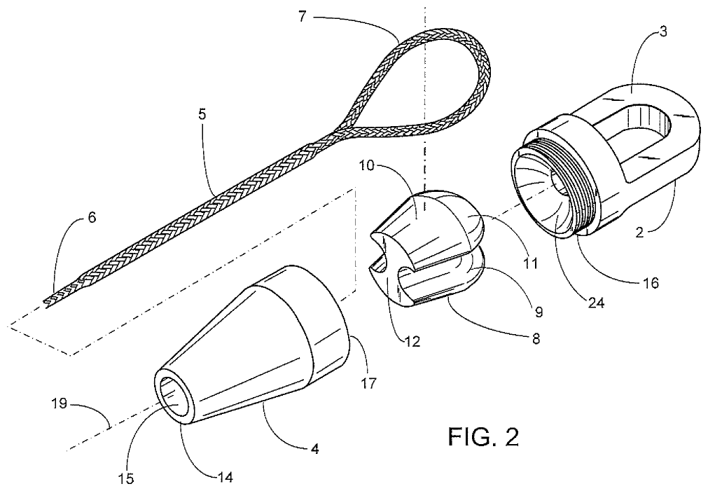

In FIG. 2, the inventive synthetic rope socket is exploded along a longitudinal axis 19 to show a tapered solid compression thimble 8 having tapered sides 10, a spherical top end 11, a bottom or rope entry end and rope exit end 12 and a longitudinal exterior contour groove 9. Above the tapered solid compression thimble 8 is shown a screw-on cap 2 with a fitting end 3 and external threads 16. Below the tapered solid compression thimble 8 is shown an enclosing thimble socket 4 with a rope entry end and rope exit end 14, a rope entry opening and rope exit opening 15 and a solid compression thimble entry end 17. For clarity, a braided synthetic rope 6 with a loop 7 and a splice 5, has been shown in juxtaposition to the tapered solid compression thimble 8 and the enclosing thimble socket 4, but it is to be understood that in assembly an end of the braided synthetic rope 6 would be inserted into the rope entry and exit opening 15 in sufficient length to be folded over the longitudinal exterior contour groove 9 of the tapered solid compression thimble 8 and spliced back onto itself beginning at the rope entry end and rope exit end 12 of the tapered solid compression thimble 8. Once the splice 5 was completed, the braided synthetic rope 6 would then be drawn back through the rope entry opening and rope exit opening 15, drawing the loop 7 and the tapered solid compression thimble 8 into the solid compression thimble entry end 17 of the enclosing thimble socket 4 before engagement of the screw-on cap 2. It is understood that the enclosing thimble socket 4, the tapered solid compression thimble 8, and the screw-on cap may be cast and/or machined. It is preferred that both the enclosing thimble socket 4 and the solid compression thimble 8 be of the same solid steel alloy to insure no electrochemical interactions. However, depending on the application, a wide range of metals or engineered materials could be utilized. It is also understood that all edges of the tapered solid compression thimble 8, as well as the rope entry and exit opening 15 of the enclosing thimble socket 4 have rounded edges for the protection of the braided synthetic rope 6.

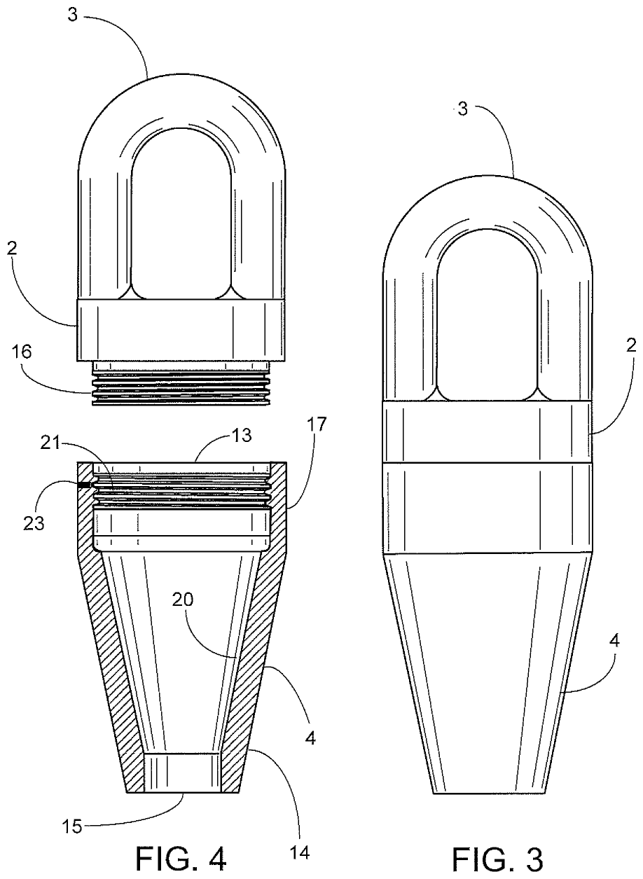

In FIG. 3, an external side view of the inventive synthetic rope socket showing enclosing thimble socket 4, screw-on cap 2 and fitting end 3 shown as an eye. While the fitting end 3 is shown as an eye, it is understood that the fitting end can be adapted to any connection point configurable for different rigging attachment styles and is not limited to an eye. Likewise while the present embodiment shows a screw-on cap 2 and fitting end 3, alternative connection means may be used to fixedly attach the cap with fitting end to the enclosing thimble socket 4.

FIG. 4 is a side view of the screw-on cap 2 with external threads 16 and a fitting end 3 shown as an eye, in position above a cross section of the enclosing thimble socket 4 with internal threads 21 at the solid compression thimble entry end 17 and an internal tapered thimble seat 20, but without the tapered solid compression thimble 8. Also shown on the enclosing thimble socket 4 is the solid compression thimble entry end 17, the solid compression thimble opening 13, the rope entry end and rope exit end 14 and the rope entry opening and rope exit opening 15. Also shown is a locking screw mechanism 23 to be engaged for locking the screw-on cap 2 in place.

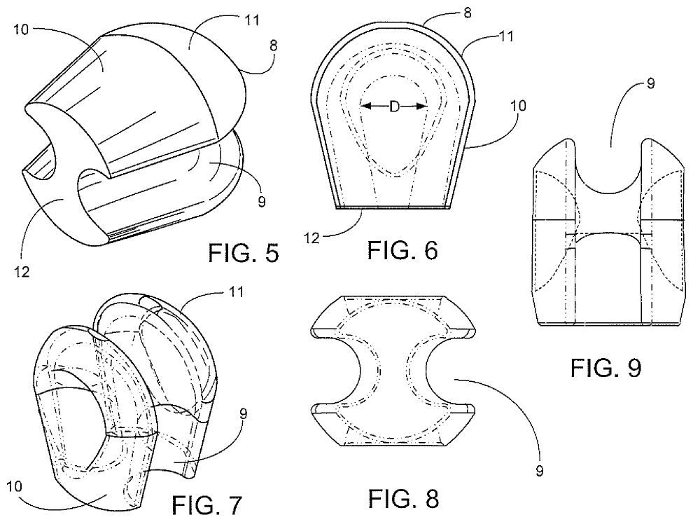

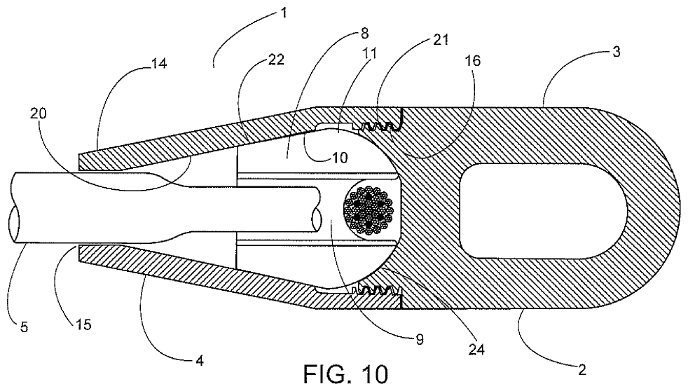

In FIG. 5 a perspective view of one embodiment of the tapered solid compression thimble 8 is shown with a tapered side 10, a spherical top end 11, a longitudinal exterior contoured groove 9, and a rope entry end and rope exit end 12. It is noted that the tapered side 10 is tapered to the same angle as the internal tapered thimble seat 20, and it is intended that the tapered side 10 is in full and direct contact with the internal tapered thimble seat 20 at the zone of contact 22 as shown in FIGS. 10 and 12. In operation, the tension on the rope 6 is absorbed by the solid compression thimble 8 and then redistributed to the enclosing thimble socket 4 to handle tensile forces on the inventive synthetic rope socket 1. The solid compression thimble 8 is the only part of the inventive synthetic rope socket 1 that experiences compressive forces. In operation, the solid compression thimble 8 eliminates the possibility of collapse or failure under load. The rope will break before compressive forces could crush the solid compression thimble 8.

An alternative embodiment of the tapered solid compression thimble 8 is depicted in FIGS. 6, 7, 8, and 9. As shown in the perspective view in FIG. 7, this embodiment of the tapered solid compression thimble 8 has been contoured to remove weight and provide a more optimized design. FIGS. 6 and 9 each shows a side view but 90 degrees apart where FIG. 9 is viewing directly into the longitudinal exterior contoured groove 9, but the groove 9 is hidden in FIG. 6. FIG. 8 is a top view. Also shown in FIG. 6 is the dimension D which is the diameter around which a braided synthetic rope 6 is bent.

FIG. 10 shows a side cross sectional view of the complete and assembled inventive synthetic rope socket 1 with tapered solid compression thimble 8 and a braided synthetic rope 6 spliced into a loop around the tapered solid compression thimble 8 in a longitudinal exterior contoured groove 9. As can be seen, the tapered solid compression thimble 8 is seated in the enclosing thimble socket 4 and the tapered side 10 of the tapered solid compression thimble 8 is in full contact with the internal tapered thimble seat 20 at the contact zone 22. Also shown are the internal threads 21 of the enclosing thimble socket 4 engaged with the external threads 16 of the screw-on cap 2 with fitting end 3 shown as an eye. As shown, the end of the screw-on cap 2 with external threads 16 has been provided with a concave opening 24 as shown in FIG. 2 to provide clearance for the spherical top end 11 of the tapered solid compression thimble 8 but the spherical top end 11 does not contact the screw-on cap 2 in the concave opening 24. The synthetic rope splice 5 extends through the rope entry opening and rope exit opening 15. It is understood that the tapered side 10 of the tapered solid compression thimble 8 is cast/machined to conform to the internal tapered thimble seat 20 of the enclosing thimble socket 4; thereby creating a nesting surface and the load being supported by the inventive synthetic rope socket 1 is transferred to the enclosing thimble socket 4 and to whatever apparatus that it is connected to and supporting the load on the system.

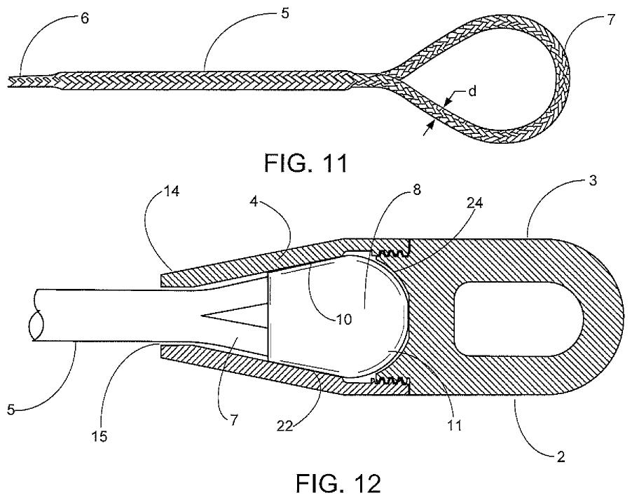

FIG. 11 is another view of the end of a braided synthetic rope 6 spliced into a loop 7 that would be formed around the tapered solid compression thimble 8 in a longitudinal exterior contoured groove 9. It is to be understood that the loop 7 would be formed with the braided synthetic rope 6 in the longitudinal exterior contoured groove 9 and spliced with the tapered solid compression thimble 8 in place in the loop 7. Also shown in FIG. 11 is the dimension d which is the diameter of the braided synthetic rope 6.

FIG. 12 is another side cross sectional view of the complete and assembled inventive synthetic rope socket 1 with the tapered solid compression thimble 8 rotated 90 degrees about longitudinal axis 19 from the view given in FIG. 10, and a braided synthetic rope 6 spliced into a loop 7 around the tapered solid compression thimble 8 in a longitudinal exterior contoured groove 9. As noted above, the spherical top end 11 of the solid compression thimble 8 does not contact the screw-on cap 2 in the concave opening 24.

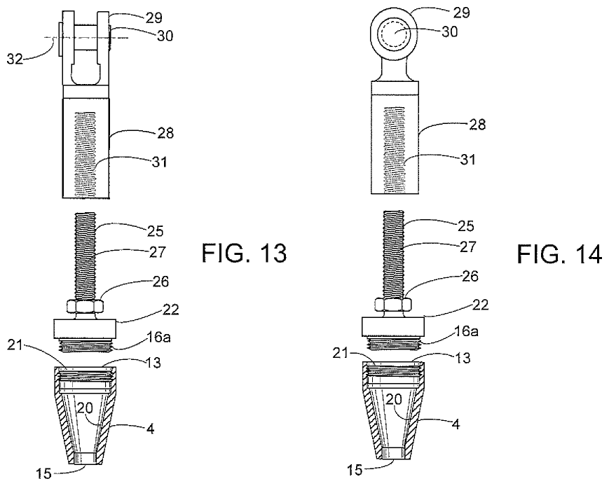

FIG. 13 shows a side view of an alternative screw-on cap 2a with external threads 16a with a fixed extension rod 25 having external threads 27 and a lock nut 26 shown below a partial cross section of an end fitting 28 with internal threads 31 and clevis jaw 29 and pin 30 on a pin axis 32, all in position above a cross section of the enclosing thimble socket 4 with internal threads 21 at the thimble opening 13 without the tapered solid compression thimble 8 seated in the tapered thimble seat 20. In FIG. 14, the end fitting 28 with clevis jaw 29 and pin 30 are rotated 90 degrees to show the clevis jaw 29 from a side for pin 32 entry on the pin axis 32. It is understood that the end fitting 28 with internal threads 31 will be threaded on the external threads 27 of the fixed extension rod 25 and locked at a desired length with the lock nut 26. It is understood that the end fitting 28 may be fitted with different rigging attachment styles and is not limited to a clevis jaw 29 and pin 30.

The morphology and structural support of the tapered solid compression thimble 8 differentiate the invention from traditional thimbles. A traditional thimble experiences both compression and tension forces since it supports the rope it is attached to and it is attached via fixtures that are placed through the open body of the thimble to whatever device or fixture that is supporting/providing a load. In contrast, the tapered solid compression thimble 8 of the inventive synthetic rope socket 1 experiences only compressive forces from (a) the downward pressure of the rope along the top of the tapered solid compression thimble 8 and (b) the upward pressure along its lower tapered side 10 from the supporting, enclosing thimble socket 4 where the tapered solid compression thimble 8 rests inside the supporting, enclosing thimble socket 4 on the internal tapered thimble seat 20 at the zone of contact 22.

The strength requirements for lifting accessories, such as shackles and wire rope termination sockets, are well researched, documented and regulated by various surveying societies and industry associations; prime examples commonly used in the mooring & rigging industries include ASME (American Society of Mechanical Engineers), ABS (American Bureau of Shipping), CE (“Conformité Européene”=“European Conformity”) and DNV-GE (“Det Norske Veritas-Germanischer Lloyd”). The metallic components are required to be stronger than the synthetic or metal rope they support. For example metallic terminations covered by the CE standards require conformity with their Machinery Directive 2006/42/EC, including section 4.1.2.5 “Lifting Accessories & their Components;” therein section (d) states “all metallic components . . . must have a working coefficient chosen in such a way to guarantee an adequate level of safety; this coefficient is, as a general rule, equal to 4;”

The strength of the inventive synthetic rope socket sized for a 1.125″-1.25″ synthetic rope has undergone structural finite element analysis with simulated rope tension and a safe working load of 35,000 lbs. in accordance with DNV 2.22 Lifting Appliance standard (June 2013).

In addition to a structural finite element analysis to predict the strength and safety factor of the inventive synthetic rope socket itself, the performance of synthetic rope (the efficacy or performance of the rope) was tested when used in the inventive synthetic rope socket. A prototype socket was tested using 1.0″ Plasma® 12 Strand rope from Cortland®. This type of rope is manufactured from High Modulus Polyethylene fiber (HMPE) and claimed by the manufacturer to be the highest strength synthetic rope available. Synthetic ropes are characterized by their Minimum Breaking Load (MBL) or Minimal Tensile Strength (MTS). MTS's are provided for both the unspliced and spliced rope. From the manufacturer's data sheet, the MTS for 1.0″ Spliced Plasma® 12 Strand is 110,000 lbs.; the MTS for unspliced 1.0″ Plasma® 12 Strand is 122,000 lbs.

A pull test apparatus was designed in accordance with industry practice and calibrated to ASTM-E-4 standards. Using the rope manufacturer's testing methodology, the 1.0″ Plasma® 12 Strand rope was pulled to 55% of the spliced MTS (0.55×110,000=60,500 lbs.) 10 times (ten cycles), allowed to “rest” or cool for 30 minutes and then the rope was pulled to a tension of 110,000 and held for 30 seconds. The tension on the rope was then increased until failure. The 1.0″ Plasma® 12 Strand rope failed at 128,400 lbs. Since this failure was over the 122,000 lbs. MTS of the unspliced rope, the inventive synthetic rope socket allowed the rope to perform well and fail above MTS for both spliced and unspliced rope. On this basis the inventive synthetic rope socket allows the rope to perform at 100% MTS or 100% efficient (based on the formula of Breaking Strength/MTS X100=% Efficiency).

In the present invention the ratio of the diameter D around which the braided synthetic rope 6 of diameter d is bent (D/d) is 1.25, while it is common practice with conventional thimbles to have a D/d of no less than 3. It is generally known that the lower the D/d ratio, the lower the strength/efficiency of the rope. However, the present invention used with HMPE rope and a D/d of 1.25 has tested to 100% MTS.

What is claimed is:

1. A device for end termination of a synthetic rope performing at least at 100% of the minimum tensile strength of the synthetic rope, comprising:
a tapered solid compression thimble with tapered sides of sufficient area to absorb the entire tension load realized by the synthetic rope, a rope entry end and rope exit end, a top end, a longitudinal exterior contoured groove with rounded surfaces for the synthetic rope of diameter d, extending from the rope entry and exit end to the top end of the tapered solid compression thimble with a diameter D around which the synthetic rope is bent and where the ratio D/d is equal to or greater than 1.2;
an enclosing thimble socket with a rope entry end and rope exit end, a rope entry end opening and rope exit end opening with rounded edges at the rope entry end for insertion of the braided synthetic rope and extension through the rope entry end to the rope entry end of the tapered solid compression thimble and folded back and placed in the contoured groove of the tapered solid compression thimble and spliced onto itself a solid compression thimble entry end, a solid compression thimble opening, an internal tapered thimble seat to receive the tapered solid compression thimble in full and direct contact between the internal tapered thimble seat and the tapered sides of the tapered solid compression thimble, internal threads in the tapered thimble seat at the solid compression thimble entry end;
a screw-on cap having a thimble socket engagement end with external threads at the thimble socket engagement end for threaded engagement with the internal threads in the tapered solid compression thimble seat at the solid compression thimble entry end of the enclosing thimble socket after the tapered solid compression thimble is seated in the enclosing thimble socket and a fitting end for rigging attachment.

2. The device for end termination of a synthetic rope of claim 1 where the screw-on cap further comprises an adjustable externally threaded extension rod to receive an internally threaded fitting end positioned as desired on the extension rod with a lock nut.

3. The device for end termination of a synthetic rope of claim 2 where the fitting end further comprises a clevis jaw and pin.

4. A method for the termination of an end of a braided synthetic rope with a device for withstanding at least at 100% of the minimum tensile strength of the synthetic rope comprising the steps of:
inserting the end of the braided synthetic rope of diameter d through an enclosing thimble socket with a rope entry end and rope exit end, a rope entry end opening with rounded edges at the rope entry end, a solid compression thimble entry end, an internal tapered thimble seat to receive a tapered solid compression thimble with a longitudinal exterior contoured groove for the synthetic rope and a rope entry end and rope exit end with a diameter D around which the synthetic rope is bent and where the ratio D/d is equal to or greater than 1.2, and internal threads in the tapered solid compression thimble seat at the solid compression thimble entry end;
drawing the end of the braided synthetic rope inserted through the rope entry end opening of the enclosing thimble socket in sufficient length to wrap the braided synthetic rope over and around the tapered solid compression thimble in the contoured groove from the rope entry end and rope exit end over a top end with rounded surfaces and splice onto itself;
splicing the braided synthetic rope onto itself after being wrapped over and around the tapered solid compression thimble in the contoured groove;
pulling the spliced synthetic rope to draw and seat the tapered solid compression thimble in the enclosing thimble socket through the solid compression thimble opening at the solid compression thimble entry end;
threading a screw-on cap with a fitting end for rigging attachment, with external threads at the solid compression thimble entry end of the enclosing thimble socket, and;
engaging a locking screw mechanism.

5. The method of claim 4 for the termination of an end of a braided synthetic rope where the screw-on cap further comprises an adjustable externally threaded extension rod to receive an internally threaded fitting end positioned as desired on the extension rod with a lock nut.

6. The method of claim 5 for the termination of an end of a braided synthetic rope where the fitting end further comprises a clevis jaw and pin.

7. The method of claim 4 for the termination of an end of a braided synthetic rope further comprising the step of wrapping the spliced braided synthetic rope in an anti-chafe material.
